(19) United States
(12) Patent Application Publication
(10) Pub. No.: US 2013/0302119 A1
(43) Pub. Date: Nov. 14, 2013

(54) CONTROL APPARATUS AND METHOD FOR REFUSE TRACK EXTENDABLE ARMS

(71) Applicant: Dean Steege, Cedar Falls, IA (US)

(72) Inventor: Dean Steege, Cedar Falls, IA (US)

(73) Assignee: Wayne Industrial Holdings, LLC, Cedar Falls, IA (US)

(21) Appl. No.: 13/470,474

(22) Filed: May 14, 2012

(51) Int. Cl. B65F 3/08

(52) U.S. Cl. CPC B65F 3/08
USPC 414/409

(57) ABSTRACT

A lift arm controller for a refuse truck has a lift arm, a gripper dimensioned for gripping and holding a refuse container, a carriage on the lift arm to translate along it and a gripper mounted on the carriage. A lift actuator is operationally attached to the carriage to translate the carriage, gripper and the refuse container along the lift arm. At least one sensor is configured to sense when the carriage is entering a near end portion of the lift arm and a signal to a controller. The controller is in operative communication with the sensor and the lift actuator and is configured to signal the lift actuator to operate at a slower speed when a signal is received from the sensor. The sensor may be an inclinometer. The inclinometer may also be used to maintain the gripper in a substantially level orientation.

### CROSS-REFERENCE TO RELATED APPLICATIONS

None.

### BACKGROUND

1. Field of the Invention

This invention is in the field of refuse collection truck equipment, especially extendable arms and grippers and the control thereof.

2. Prior Art

Refuse trucks have long had a variety of extendable apparatuses such as arms for engaging grippers with garbage cans, dumpsters, and the like, in order that they may be lifted and their contents dumped into the hopper of a refuse truck. These apparatuses are typically fairly heavy steel devices commonly driven by hydraulics. There is a constant need in the art for smooth operation of such apparatuses in order that the trash and garbage in containers being dumped be efficiently deposited into the refuse truck without spillage, and that the apparatuses remain durable through many cycles of use. In the state of the art, devices used for control of lift arms, extensions, grippers, and other apparatuses used to reach out, grasp, lift and dump garbage cans and dumpsters have been mechanical or hydraulic in nature, such as springs, or dual-action hydraulic cylinders.

Refuse trucks also have multiple apparatuses and systems for executing multiple necessary steps in the collection of refuse. For example, after lifting and dumping trash into a hopper, the trash is packed and compressed by a separate compression mechanism. Due to the space limitations and other practical considerations, all of these multiple systems need to be assembled onto a single truck and operate together. In the prior art, where space considerations forced certain apparatuses such as packers and lifters to occupy the same space, the solution has been to simply operate them sequentially, having a consequent loss of time efficiency in many circumstances.

### SUMMARY OF THE INVENTION

The present invention is a control system for a lifting and dumping apparatus for a refuse truck.

A lift arm controller for a refuse truck has a lift arm, a gripper dimensioned for gripping and holding a refuse container, a carriage disposed on the lift arm to translate along it and a gripper mounted on the carriage. A lift actuator is operationally attached to the carriage to translate the carriage, gripper and the refuse container along the lift arm. The lift actuator has a faster speed and a slower speed. At least one sensor is disposed to sense when the carriage is entering a near end portion of the lift arm and is configured to send a signal to a controller when the carriage is entering a near end portion of the lift arm. The controller is in operative communication with the sensor and the lift actuator and is configured to signal the lift actuator to operate at the slower speed when a signal is received that the carriage has reached the lift arm end portion. The sensor may be an inclinometer. The inclinometer may also be used to maintain the gripper in a substantially level orientation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic overview of a refuse truck.

FIG. 2 is a schematic side view of an extension arm and gripper apparatus for a refuse truck.

### DETAILED DESCRIPTION

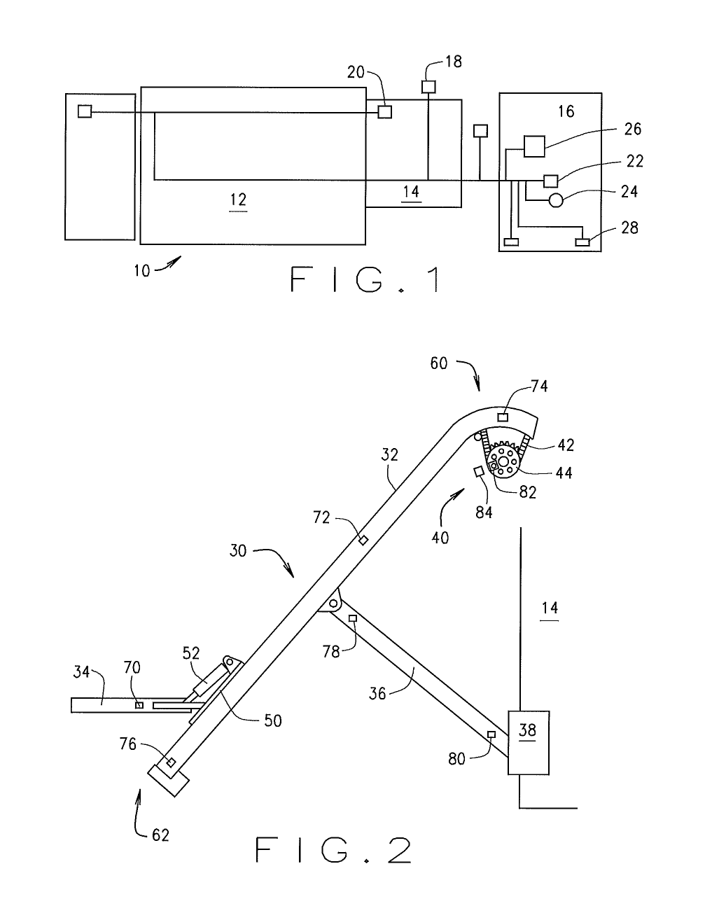

Referring now to the figures in which like reference numbers indicate like elements, FIG. 1 is a schematic top view of a refuse truck 10. Refuse truck includes a refuse compartment 12, receiving hopper 14, and a cab 16. Refuse is deposited in the hopper 14 by a lift and dump apparatus 18. Trash is managed on board by a compressor packer apparatus 20. An operator may control the functions of various systems on the refuse truck from the cab 16 using a central process system, adding a central processor 22 in operative electric communication with the motors, hydraulics and other equipment described below for executing necessary movements for refuse collection. The operating system may also include controls such as, for example, a joy stick 24, a panel of switches 28, and a display 26.

FIG. 2 is a schematic side view of refuse collection lifting and dumping apparatus 30. The components of the lifting and dumping apparatus 30 include an extending arm 32 configured to extend in a position to engage a garbage can, a gripper 34 typically comprised of a pair of horizontal pincers whose structure and function are well known to those skilled in the art. The extending arm 32 may be extended by any of a variety of apparatuses for that purpose, which typically include some sort of drive arm 36 engaged with a powered driver, for example, a hydraulic arm indicated schematically at 38. In this manner, the truck may remain parked on the street, while the extension apparatus 30 extends to engage the gripper 34 with the trash can or dumpster to be dumped.

Having engaged the trash can in a known manner, the grippers must be elevated to a position where the trash can may be emptied into the hopper 14. This is typically executed by a lift mechanism 40 which is often comprised of a lift chain 42 driven by a sprocket 44 powered by a driver such as a hydrostatic motor, which is omitted from FIG. 2 for clarity. The chain 42 extends through any of a variety of known guides and idlers down the extension arm 32 to a position where it is engaged with a carriage 50. The gripper assembly 34 is mounted on the carriage 50. This mounting includes a leveler for the grips 34 which may be, for example, a hydraulic arm 52. Upon receiving a signal, the lift power supplied, for example, by a hydrostatic motor, turns the sprocket 44, which in turn drives the chain 42 which translates the carriage 50 up and across the extension arm 32 in order to lift the grip assembly 34 and the trash can.

At the top of the extension arm 32, the trash is dumped by tilting or inverting the trash can with the grippers 34. This may be done actively, or, as in the depicted embodiment, by rotating the trash can in order to invert it and empty its contents. This rotation may be actuated with a curved upper portion of the extension arm 60. By rounding the curve, the carriage 50 will tilt the grippers 34 in order to invert the trash can and empty it into the hopper 14. Thereafter, upon receipt of a signal, the hydrostatic motor can reverse the drive of the sprocket 44 and chain 42 in order to translate the carriage 50 back down the extension arm 32 to its lower end 62 for positioning the trash can proximate to the ground once again and thereafter signaling the grippers 34 to release it.

The control system of the present invention deploys a variety of sensors throughout the lifting and dumping apparatus. These sensors include an inclination sensor 70 on the gripper assembly 34 and an inclination sensor 72 on the extension arm 32. Sensors may also include terminal proximity sensors 74 and 76 at the upper 60 and lower 62 end portions of the extension arm 32. Proximity sensors may further be deployed along the extension drive apparatus 36 such as depicted at 78 and 80. Proximity sensors may be further deployed in the drive apparatus 40 such as those depicted at 82 and 84. The sensors indicated are all in electric signal transmission communication with a central control system, and more particularly a central processor 22. Some proximity sensors such as those at 78 and 80 may be deployed to indicate when the extension drive apparatus is fully extended and fully retracted. More particularly, these proximity sensors may be deployed near, but not at the end stop of, a fully deployed or fully retracted position. By sensing when a movement of the heavy, hydraulically driven apparatus is near its end, the receipt of the near-the-end signal from the sensor 78 or 80 may be received by the central processor 22 and may be followed by a deceleration signal from the central processor 22 to the drive means 38 for the apparatus' movement has been sensed to be nearly complete. By decelerating the movement of the heavy parts before an end stop, hard impacts that shorten the useful lifespan of the overall apparatus may be advantageously avoided.

Such damaging impacts are particularly noticeable in chain drive apparatuses. Accordingly, useful lifetime-preserving deceleration signals may be sent in response to near-the-end signals received from proximity sensors such as 74 or 76 disposed at either end of a range of travel of a chain-driven apparatus such as along the extension arm 32. Additionally, or alternatively, the position of the carriage 50 and its load may be tracked by monitoring the chain itself 42. Hence, a proximity sensor may be disposed at position 84 to sense the proximity of chain links or link pins in sequence and to activate a counter as they pass. The central processor 22, having been initialized with a known number of chain links or link pins, may thereby monitor the position of the carriage 50 and load along their vertical translation up and down extension arm 32. Alternatively, a sensor 82 may be disposed to count the passage of bolts or the components of the sprocket 44 as they pass, also thereby monitoring the position of the load. Another alternative is to engage both the chain links and the sprocket in order to have an advantageous sense of a coarse measurement and a fine measurement of the position of the carriage 50 and load.

The control system of the present invention also monitors the inclination of the grippers 34 in order to advantageously control them to maintain them and their load in a horizontal position relative to the ground as they are lifted vertically and diagonally while translating along the extension arm 32. Hence, the inclination sensor 70 signals the central processor 22 with a signal of the inclination of the grippers 34. Either continuously or in response to passing preconfigured thresholds, the central processor is preconfigured to output signals to the gripper leveler hydraulic cylinder 52 to execute a compensating extension or retracting of its hydraulic arm in order to tilt the grippers in a manner to maintain them in a horizontal position until they reach the top of the extension arm 60. At the top of the extension arm 60, the controller receives a signal indicating the arrival of the carriage 50 at the top, and thereafter outputs a signal to the gripper leveler 52 to either stop compensating, or actively retract in order to pull the grippers further over and execute the dump of the garbage can contents.

Another inclinometer or inclination sensor 72 may be placed on the extension arm itself, or, in the alternative, on the extension driver apparatus 36. Critical inclinations may be preconfigured in the control processor to change its output signals as described below. Because of the space constraints in refuse trucks, the top portion 60 of the extension arms and some configurations, particularly those that are designed to pivot at their top, cause the top end 60 of the extension arm 32 to project into the hopper, which is disadvantageous for packing processes as the packer may impact the extension arm 32. The present invention may advantageously output signals that alter the stop point for movement of the carriage 50 and its load upwards and towards the hopper. At higher angles of inclination, where the truck and trash can are originally closer together, the output signal would cause the carriage to travel farther around the curve at the top 60 of the extension arm 32 in order to ensure the trash can's contents are dumped. However, at greater or more horizontal extension angles, the inclination sensor 72 may indicate those angles to the central processor 22, which may thereafter output a signal to the drive chain driver to stop at a position short of the very top end of the extension arm 32. Because the apparatus thus extended is already inclined somewhat, only a marginally decreased amount of further inclination is needed to dump the contents. By achieving the unloading of the can without full travel of the carriage 50, the packing apparatus may be engaged earlier, since the carriage, load and other components of the extension apparatus 30 are clear of the packer's operational travel, thus advantageously saving time.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A lift arm controller for a refuse truck comprising:
a lift arm;
a gripper dimensioned for gripping and holding a refuse container;
a carriage, said carriage being disposed on said lift arm to translate along said lift arm and said gripper being mounted on said carriage;
a lift actuator, said lift actuator being operationally attached to said carriage to translate said carriage, said gripper and the refuse container along said lift arm;
said lift actuator having a faster speed and a slower speed;
at least one sensor, said sensor being disposed to sense when said carriage is entering a near end portion of said lift arm and said sensor being configured to send a signal to a controller when said carriage is entering a near end portion of said lift arm; and
said controller being in operative communication with said sensor and said lift actuator and said controller being configured to signal said lift actuator to operate at said slower speed when a signal is received that said carriage has reached said lift arm end portion.

2. The lift arm controller of claim 1 wherein said sensor is an inclinometer.

3. The lift arm controller of claim 1 further comprising:
an inclinometer, said inclinometer being disposed to sense an incline of said gripper, said inclinometer being further configured to send a signal to said controller with a sensed data about the gripper inclination;
a leveler, said leveler being disposed to move said gripper; and
said controller being configured to send a move signal to said leveler to make a leveling movement such that said gripper maintains a preconfigured orientation relative to the lift arm or ground.

4. The lift arm controller of claim 3 wherein said preconfigured orientation of said gripper is substantially level.
